(19) United States
(12) Patent Application Publication
(10) Pub. No.: US 2010/0179837 A1
(43) Pub. Date: Jul. 15, 2010

(54) METHODS AND SYSTEMS FOR REPLACING INSURED ITEMS

(76) Inventor: Charles Kurt Artinger, Belleville, IL (US)

Correspondence Address: Patent Docket Department;Armstrong Teasdale LLP, One Metropolitan Square, Suite 2600, St. Louis, MO, 63102-2740, US

(21) Appl. No.: 12/353,067

(22) Filed: Jan. 13, 2009

(51) Int. Cl. G06Q 40/00; G06F 3/048

(52) U.S. Cl. 705/4; 715/708

(57) ABSTRACT

A method for replacing insured items using a web-based system including a server and at least one device connected to the server via a network is provided. The method includes receiving at the server specification information about an insured item to be replaced. The specification information includes at least one feature of the insured item. The method further includes comparing the received item specification information with potential replacement product information pre-stored within at least one of the server and a database to identify at least one comparable item that is comparable to the insured item and compiling a list of the at least one comparable item. The list includes specification information related to the at least one comparable item. The method also includes displaying the compiled list to at least an insured, selecting the at least one comparable item for comparison with the insured item, and displaying a comparison between at least one feature of the at least one comparable item and at least one feature of the insured item.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

The embodiments described herein relate generally to computer network-based systems for replacing insured items and, more particularly, to a network-based method and system for providing information to an insured user during replacement of an insured item.

Items of value are typically insured with insurance companies to offset the cost of replacing the item if an event occurs such that the item needs replacing. For example, jewelry is often insured to enable an owner to offset the cost of replacing the jewelry in the event the jewelry is lost, damaged, or stolen. Typically, after such an event occurs, the owner contacts the insurance company and files a claim to have the jewelry replaced. To file the claim, the owner typically files proof of ownership of the jewelry, often using a receipt that shows a purchase date and an amount of purchase of the jewelry and/or appraisal of the jewelry.

The claim is evaluated by a claims adjuster to determine a value of the originally-insured jewelry in comparison to the value of the insured property and either the owner, the insurance company, or both attempt to find a suitable replacement. However, the owner and/or the insurance company may not be aware of the other party's efforts in finding a replacement, which may lead to confusion and/or frustration. The insurance company's responsibility to the insured, according to the policy, may be to repair or replace the insured item at the insurance company's cost, which may be a lower price than the insured amount. The claims adjuster also compares the proposed suitable replacement costs and repair costs, if applicable, to the value of the insured item. However, the insured may only see the final proposed items without understanding how those items were chosen. Further, the insured may disagree with the replacement selections because the insured is not involved in the selection process and/or the selection process is performed without the insured being aware of the selection process.

Often the process may be cumbersome or time-consuming, and may require many interactions between the insurance company and the owner, the insurance company and third parties, and/or the owner and the third parties. Further, the insured may not be aware of the suitable replacements that were found, why a particular replacement was chosen, and/or other information relating to what makes an item a comparable replacement. Eventually either the owner is issued a check to purchase the replacement item, or the insurance company issues a check directly to a merchant offering the replacement item for sale.

The above-described process may be unclear to the insured, and can result in frustration for the insured and/or miscommunication between parties. Accordingly, there is a need to make the replacement process more transparent for the insured. Further, it is desirable to provide information to the insured during the process to reduce miscommunication between parties.

### BRIEF DESCRIPTION OF THE INVENTION

In an exemplary embodiment, a method for replacing insured items using a web-based system including a server and at least one device connected to the server via a network is provided. The method includes receiving at the server specification information about an insured item to be replaced. The specification information includes at least one feature of the insured item. The method further includes comparing the received item specification information with potential replacement product information pre-stored within at least one of the server and a database to identify at least one comparable item that is comparable to the insured item and compiling a list of the at least one comparable item. The list includes specification information related to the at least one comparable item. The method also includes displaying the compiled list to at least an insured, selecting the at least one comparable item for comparison with the insured item, and displaying a comparison between at least one feature of the at least one comparable item and at least one feature of the insured item.

In another aspect, a system for facilitating replacement of an insured item of an insured is provided. The system includes a plurality of devices and a server coupled to the plurality of devices. The server is configured to receive specification information data from a first party about the insured item via a first device of the plurality of devices, wherein the specification information includes at least one of a feature of the item. The server further includes an interface configured to compare the received item specification information with potential replacement product information pre-stored within at least one of the server and a database to identify at least one comparable item that is comparable to the insured item, and compile a list of the at least one comparable item. The list includes specification information related to the at least one comparable item. The interface is further configured to display the compiled list to at least the insured via a second device of the plurality of devices, prompt the insured to select the at least one comparable item for comparison with the insured item, and display a comparison between at least one feature of the at least one comparable item and at least one feature of the insured item.

The above-described embodiments provide a more transparent replacement selection process for the insured and provide pertinent information to the insured throughout the replacement process.

### BRIEF DESCRIPTION OF THE DRAWINGS

FIG. 1 is an exemplary system block diagram.

FIG. 2 is an exemplary flow chart of a web-based method for providing claim information and/or replacement item options to an insured for an insured item.

FIG. 3 is an exemplary additional information selection web page that may be used with the system shown in FIG. 1 and/or to implement the method shown in FIG. 2.

FIG. 4 is an exemplary log-in page that may be used with the system shown in FIG. 1 and/or to implement the method shown in FIG. 2.

FIG. 5 is an exemplary insured home page that may be used with the system shown in FIG. 1 and/or to implement the method shown in FIG. 2.

FIG. 6 is an exemplary communication page that may be used with the system shown in FIG. 1 and/or to implement the method shown in FIG. 2.

FIG. 7 is an exemplary hints page that may be used with the system shown in FIG. 1 and/or to implement the method shown in FIG. 2.

FIG. 8 is an exemplary pre-formatted spreadsheet that may be used with the system shown in FIG. 1 and/or to implement the method shown in FIG. 2.

FIG. 9 is an exemplary Market Evaluation Report (“MER”) page that may be used with the system shown in FIG. 1 and/or to implement the method shown in FIG. 2.

FIG. 10 is an exemplary comparison page that may be used with the system shown in FIG. 1 and/or to implement the method shown in FIG. 2.

FIG. 11 is an exemplary Comparables page that may be used with the system shown in FIG. 1 and/or to implement the method shown in FIG. 2.

FIG. 12 is an alternative home page that may be used with the system shown in FIG. 1 and/or to implement the method shown in FIG. 2.

FIG. 13 is an exemplary educational page that may be used with the system shown in FIG. 1 and/or to implement the method shown in FIG. 2.

### DETAILED DESCRIPTION OF THE INVENTION

The embodiments described herein provide a user-friendly interface for an insured to view information related to an insurance claim. More specifically, the embodiments described herein allow the insured access all relevant information related to the insurance claim. For example, the insured can access claim status, information about an insurance agent and/or vendors, comparisons between an insured item and a replacement item, and/or educational information about tasks and/or items related to a repair and/or replacement process. The embodiments described herein may be modified according to, for example, the type of insurance claim and/or the requests of an insurance company.

In one embodiment, the insurance claim is a jewelry loss, and the system enables the insured to view information related to a jewelry claim. Such information includes, but is not limited to including, an estimate, replacement items, a feature-by-feature comparison between each replacement item and the insured item, information to educate the insured about jewelry and/or jewelry terminology, and/or contact information and/or ratings for the insurance company's preferred vendors. In an alternative embodiment, the insurance claim is for a real property loss, and the system enables the insured to view information related to a real property claim, such as an estimate, a feature-by-feature comparison between each replacement item and the insured item, information to educate the insured about an aspect of real property, terminology related to real property, and/or contact information and/or ratings for the insurance company's preferred vendors. Accordingly, when the insured would like any suitable information related to an insurance claim, the embodiments described herein allow the insured to access the information using a single web-based system.

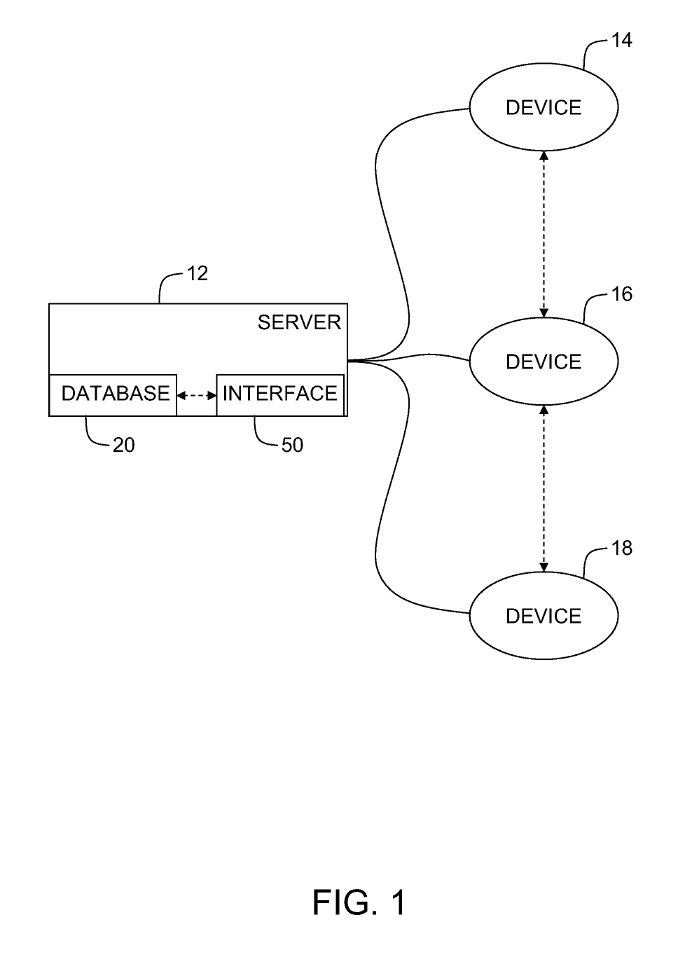

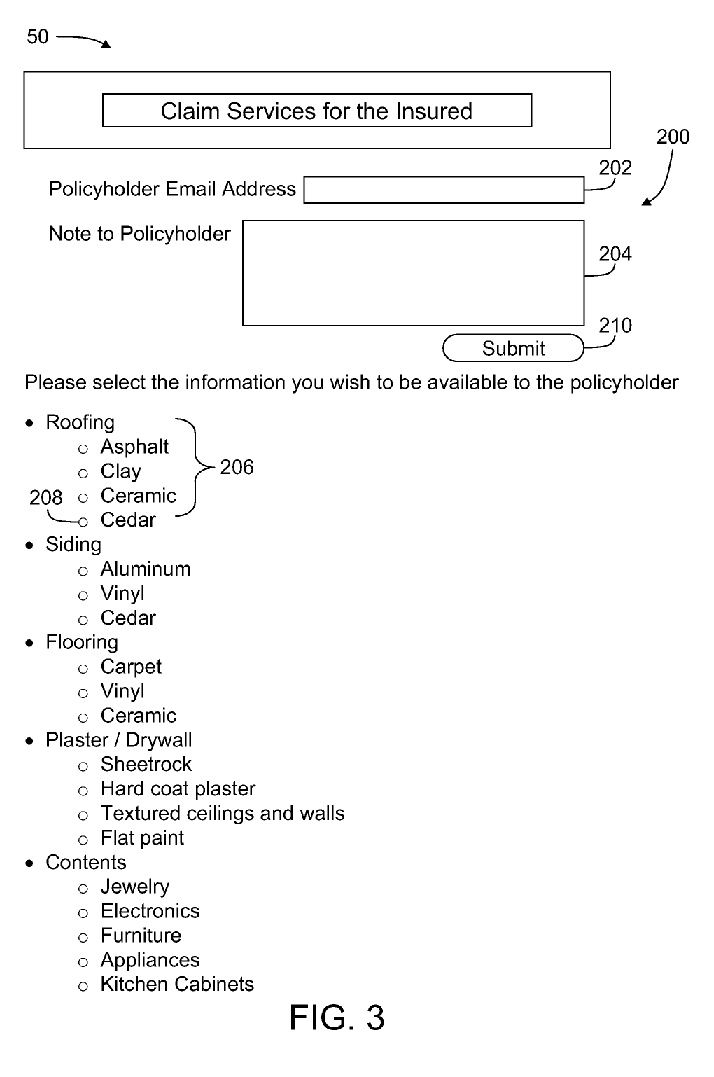

FIG. 1 is a block diagram of an exemplary embodiment of a system 10 that may be used with an exemplary web-based interface 50, as described herein. In the exemplary embodiment, interface 50 includes a plurality of web pages, such as web pages shown in FIGS. 3-13. System 10 includes a server 12 and a plurality of devices 14, 16, and 18 connected to server 12. Server 12 is used to host web-based interface 50. More specifically, information, interfaces, and/or web pages described herein are stored on server 12 in, for example, a database 20, for access by a party using system 10. In an alternative embodiment, database 20 is communicatively coupled to server 12, rather than being stored in server 12. In the exemplary embodiment, database 20 having at least replacement item information is stored on server 12 and can be accessed by at least one of the parties at one of devices 14, 16, or 18 by logging onto server 12 through one of devices 14, 16, or 18.

In the exemplary embodiment, devices 14, 16, and/or 18 are computers including a web browser, and server 12 is accessible to devices 14, 16, and/or 18 via the Internet. In an alternative embodiment, devices 14, 16, and/or 18 are servers for a network of customer devices. In the exemplary embodiment, devices 14, 16, and/or 18 are interconnected to the Internet through many interfaces including through a network, such as a local area network (LAN) or a wide area network (WAN), through dial-in-connections, cable modems and/or special high-speed ISDN lines. Alternatively, devices 14, 16, and/or 18 could be any device capable of interconnecting to the Internet including a web-based phone or other web-based connectable equipment.

In one embodiment, devices 14, 16, and 18 include an insured's device 14, an insurance agent's device 16, and a third party representative's device 18. As such, multiple parties can access server 12 for uploading and/or downloading information from server 12. For example, insurance agent's device 16 is used for uploading at least information related to an insurance claim, third party representative's device 18 is used to at least integrate the uploaded information into web-based interface 50 and insured's device 14 is used to access the uploaded information through interface 50. Alternatively, devices 14, 16, and/or 18 may be used in any suitable manner as described herein. In the exemplary embodiment, system 10 facilitates an easy and efficient method for compiling and/or accessing information related to an insurance claim. Further, system 10 is network based and is configured to permit users to access system 10 from remote locations through devices 14.

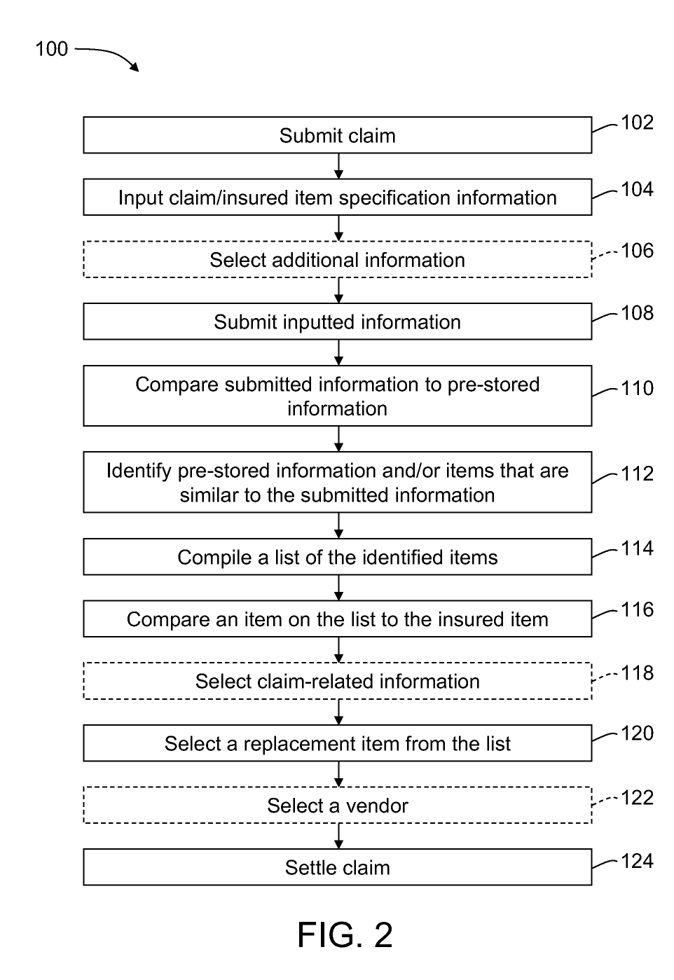

FIG. 2 is a flow chart for a web-based method 100 for providing claim information and/or replacement item options to an insured for an insured item. In an exemplary embodiment, method 100 is implemented on a computer system, such as system 10 (shown in FIG. 1) using a web-based interface, such as interface 50 (shown in FIG. 1). In one embodiment, the insured items include, but are not limited to, jewelry items. Alternatively, the items include any item eligible for insurance coverage and potentially replaceable when insurance claims are filed, such as, but not limited to, structures, home furnishings, and/or automobiles.

Initially, in the exemplary embodiment of method 100, after a claim has been submitted 102 to an insurance company by the insured, the insurance agent, such as an insurance adjuster, the insured, or the third party representative, such as a replacement representative, inputs 104 claim and/or insured item specification information into system 10. Claim information may be, for example, information about the insured, the type of claim, deductibles, limits, adjuster information, and/or any other suitable information related to the claim. The product information may be, for example, an identification of insured item features, an identification of any applicable accessories for the insured item, make, model, serial number, size, condition, color, and/or any other information describing the insured item that can be used to replace the insured item. In the exemplary embodiment, the item features may include, but are not limited to including, jewelry material information, such as, but not limited to the type of metal, gem stone shape, gem stone weight, gem stone color, and gem stone clarity. Additional features include, but are not limited to, secondary gem stone types, secondary gem stone colors, secondary gem stone weight, and secondary gem stone clarity. In one embodiment, the user inputs or submits the information into a device, such as device 14 (shown in FIG. 1), which transmits the information to a server, such as server 12 (shown in FIG. 1).

Further, the insurance agent and/or the third party representative may optionally submit 106 selections of additional information accessible by at least the insured. More specifically, the additional information is information about topics related generally to the claim, but does not include information specific to the claim. For example, for a jewelry loss of a diamond ring, the claim and/or insured item specification information includes information specifically about the claim and/or the insured diamond ring that was lost, and the additional information includes information about diamonds, settings, labor, and/or other gem stones. Alternatively, for other types of insurance claims, the topics of the additional information is selected 106 to correspond to items and/or tasks related to, for example, the insured item, a replacement option, a repair process, and/or a replacement process. In the exemplary embodiment, the additional information is made accessible to at least the insured, as described in more detail below.

At least the inputted information is submitted 108 to, for example, the third party representative and/or any other suitable third party, to find comparable items that may be used to replace the insured item. Alternatively, the insurance agent may use the inputted information to find comparable items. In the exemplary embodiment, the submitted information is compared 110 to pre-stored information within a local database, such as database 20 (shown in FIG. 1), and/or a remote database that is accessible by server 12. The pre-stored information includes item features and accessories information. The submitted information is compared 110 to the pre-stored information to determine if any items contained in the pre-stored information satisfy the product specifications submitted. In addition, the submitted information is compared 110 to pre-stored information to assess the suitability of a replacement option. In the exemplary embodiment, the submitted information is compared 110 to pre-stored information to determine whether a resulting product and/or service having the submitted insured item specifications is capable of meeting parameters of the indicated insured product. For example, in one embodiment, the submitted information is compared 110 to pre-stored information to determine whether immediate replacement items are available for the selected item configuration, whether a preferred vendor provides a suitable repair and/or replacement service, and/or whether features of a replacement item differ from features of the insured item. In the exemplary embodiment, the pre-stored information is information based on an item, such as, for example, a jewelry item, for sale at the time of the comparison 110.

In one example of the comparison step, the insurance agent compares 110 the insured item information to pre-stored item information to find comparable items for generating an estimate of the value of the loss. The comparable items may be found using any database accessible by insurance agent's device 16. In another example of the comparison step, the third party representative compares 110 the insured item information to pre-stored information stored in any database accessible to third party representative's device 18 to find comparable items. In one embodiment, the third part representative can use a database controlled by the third party and/or a database controlled by a remote vendor, such as a vendor that is preferred by the insurance company.

In the exemplary embodiment, if the product resulting from the received information does not meet the parameters of the insured item, in the exemplary embodiment, system 10 guides a user, such as the insurance agent and/or the third party representative, by providing suggestions for a correct item configuration. In an alternative embodiment, system 10 guides the user by providing information regarding alternative products that may be compatible with the item parameters supplied by the user. In a further alternative embodiment, system 10 prompts the user by providing information regarding products that are potential upgrades for the item parameters supplied by the user.

Pre-stored item information is then identified 112 that substantially matches the submitted information submitted and then those items pertaining to that pre-stored information are complied 114 into a list of comparable items. In the exemplary embodiment, the compiled list includes the item information, such as an item identifier description and/or an associated price for each selected item. For example, in one embodiment, the item identifier description is a jeweler's description suitable for insurance quotes, and the price represents a real-time retail price of the product. The price may also represent a settlement or “cash buyout,” or “cash-out,” price available to the insured if the insured elects to receive a monetary settlement payment, rather than a suitable replacement. Server 12 displays the compiled list of items, identifier numbers, and associated prices information to at least one device 14, 16 and/or 18 (shown in FIG. 1), such that a user, for example, the insurance agent and/or the insured, can view compiled list and associated information for potential replacement selections.

The compiled list of comparable items includes an option to compare 116 a comparable item to the insured item. More specifically, in the exemplary embodiment, a market evaluation report (“MER”), as described in more detail below, includes information relating to the comparable item and the insured item, feature-by-feature, to describe the similarities and differences between the comparable item and the insured item. The MER also includes real-time information, such as price and availability, for the comparable item. An MER is available for each comparable item in the compiled list. In the exemplary embodiment, the insured compares 116 one of the comparable items on the list to the insured item by selecting an MER to view at least feature comparisons and/or real-time price and availability information related to the comparable item and/or the insured item.

Further, in the exemplary embodiment, system 10 allows the insured to optionally select 118 claim-related information corresponding to the claim and/or replacement items. More specifically, the insured selects 118 the claim-related information that includes, but is not limited to including, claim status, timelines, vendors, educational resources, general product information, glossaries, and/or any other information pertinent to the claim that may enable the insured to understand the claim and/or the replacement process. In one embodiment, the insured selects 118 the additionally information as the claim-related information.

In the exemplary embodiment, once the insured has reviewed the claim, the comparable items, and/or any other pertinent information, the insured selects 120 at least one comparable item from the compiled list to replace the insured item and/or at least one vendor from a list of preferred vendor to perform a repair and/or replacement service. Alternatively, the insured may choose a “cash buyout” or “cash-out” in lieu of replacing the insured item, however, the comparable items and/or estimated labor costs may be used to quote an amount for the “cash buyout” or “cash-out.” In the exemplary embodiment, when the insured selects 120 a comparable item from the compiled list, the comparable item is ordered by, for example, the insurance agent and/or the third party representative, and is shipped directly to an address designated by the insured. Further, in the exemplary embodiment, when the insured optionally selects 122 a preferred vendor, the preferred vendor is notified by, for example, the insurance agent and/or the third party representative. After the insured selects 120 a comparable item to replace the insured item, a vendor to perform a repair/replacement service, and/or cashes out, the claim is settled 124 by the insurance company and/or the insurance agent.

Alternatively, comparable items are found and/or selected for replacement using any suitable method, such as the methods described in U.S. Pat. No. 6,873,958, issued Mar. 29, 2005, U.S. patent application Ser. No. 11/064,639, filed Feb. 24, 2005, and/or U.S. patent application Ser. No. 11/781,675, filed Jul. 23, 2007, all of which are hereby incorporated by reference and are each invented by the inventor of the embodiments described herein.

Web pages 200, 300, 400, 500, 600, 800, 900, 1000, 1100, and 1200 and spreadsheet 700 described herein form web-based interface 50 for performing method 100 using system 10. It will be understood that other web pages, in addition to web pages 200, 300, 400, 500, 600, 800, 900, 1000, 1100, and/or 1200 and/or spreadsheet 700, can also be used form web-based interface 50. For example, web-based interface 50 can include upload/download pages, main information pages, pages that display multiple insureds' files, insurance company files, and/or third party files, navigation pages, information pages, help pages, any/or any other suitable web pages for performing the steps and/or methods described herein.

FIG. 3 illustrates an exemplary additional information selection web page 200 that may be used when navigating through web-based interface 50 of system 10 (shown in FIG. 1). More specifically, an insurance agent can access page 200 using a device, such as device 16 (shown in FIG. 1), to navigate web-based interface 50 of system 10. In the exemplary embodiment, system 10 and method 100 (shown in FIG. 2) are used by at least the insured, the insurance agent, and the third party representative to process an insurance claim.

To perform method 100, in the exemplary embodiment, the insurance agent, such as an insurance adjuster, submits 108 (shown in FIG. 2) claim and/or insured item specification information to server 12 (shown in FIG. 1) using, for example, device 16. More specifically, the insurance agent uploads a pre-stored file having the information contained therein, such as a Portable Document Format (PDF) file and/or a spreadsheet of an estimate, to server 12, exports the information to server 12, and/or enters the information into web-based interface 50 stored on server 12. Alternatively, the insurance agent may submit the claim and/or insured item specification information to the third party representative in any suitable form, and the third party representative uploads, exports, and/or enters the information into server 12. In the exemplary embodiment, claim and/or insured item specification information is stored on server 12 and/or in database 20 (shown in FIG. 1) for later access by any authorized party, as described in more detail herein. More specifically, a file is created on server 12 and/or in database 20 for the insured. This file is referred to herein as the insured's file. It should be understood that the insured's file can include one or more digital documents and/or electronic files. Further, a separate file can be created for each claim the insured reports and/or the insured's file can include information related to all claims reported by the insured. In the exemplary embodiment, access to the insured's file is limited to only those parties, such as the insurance agent handling the claim, the third party representative handling the claim, and the insured, that are authorized to access the insured's file.

Once the information is submitted to system 10, the insurance agent can select 106 (shown in FIG. 2) the additional information to display to the insured when the insured accesses claim information as described herein. More specifically, the insurance agent uses page 200 to select additional information related to, for example, but not limited to, the claim, a repair process, a replacement process, an insured item, and/or a replacement item. In the exemplary embodiment, page 200 includes an identification box 202, a note box 204, and at least one group 206 of checkboxes 208. Identification box 202 is used to enter information that identifies the insured, such as an email address, to link and/or store the selections made on page 200 to the insured's file. Note box 204 can be used to enter a message that will be accessible to the insured and/or the third party representative, as described in more detail below. More specifically, the entered messages are stored in the insured's file for later access when a “Submit” button 210 is selected.

In the exemplary embodiment, checkboxes 208 enable the insurance agent to select which additional information will be available to the insured through interface 50 as accessible to the insured. More specifically, a group 206 of checkboxes 208 is displayed for each item of the insurance claim. Although a plurality of checkboxes 208 are shown in each group 206, it should be understood that a group 206 may include only one checkbox 208. Further, any other suitable selection device may be used in place of and/or in addition to checkboxes 208. In the exemplary embodiment, for a real property loss claim, the insurance agent can select to make accessible information related to the real property loss, such as, for example, roofing information, siding information, flooring information, plaster/drywall information, and/or information about the contents within the real property. Alternatively, the insurance agent selects from any suitable additional information related to the claim, the insured item, and/or a replacement item. In an alternative embodiment, rather than the insurance agent selecting the additional information, the third party representative can select the additional information using page 200.

Once the insurance agent submits the claim and/or insured item information and/or the additional information selections, comparable items and/or preferred vendors are found. More specifically, comparable items are found using the methods described herein and/or any other suitable method for finding items that are comparable items to the insured item for replacing the insured item. For example, the insurance agent and/or the third party representative finds comparable items using item information pre-stored in an insurance company database, the third party's database, a vendor's database, and/or any suitable database. Once the comparable items are found, a list of the comparable items is compiled 114 (shown in FIG. 2). The list includes item descriptions, prices, availability, and/or any other relevant information about each comparable item on the list. More specifically, in the exemplary embodiment, the item descriptions include a list of features of a comparable item such that the comparable item can be compared to the insured item feature-by-feature, as described herein. Further, in the exemplary embodiment, item descriptions are real-time descriptions of each comparable item, wherein the item descriptions are updated at any suitable subsequent time and/or according to an update schedule. In one embodiment, each time the insured accesses the compiled list, the items descriptions are updated. In the exemplary embodiment, the compiled list, including item descriptions, is stored within the insured's file on server 12.

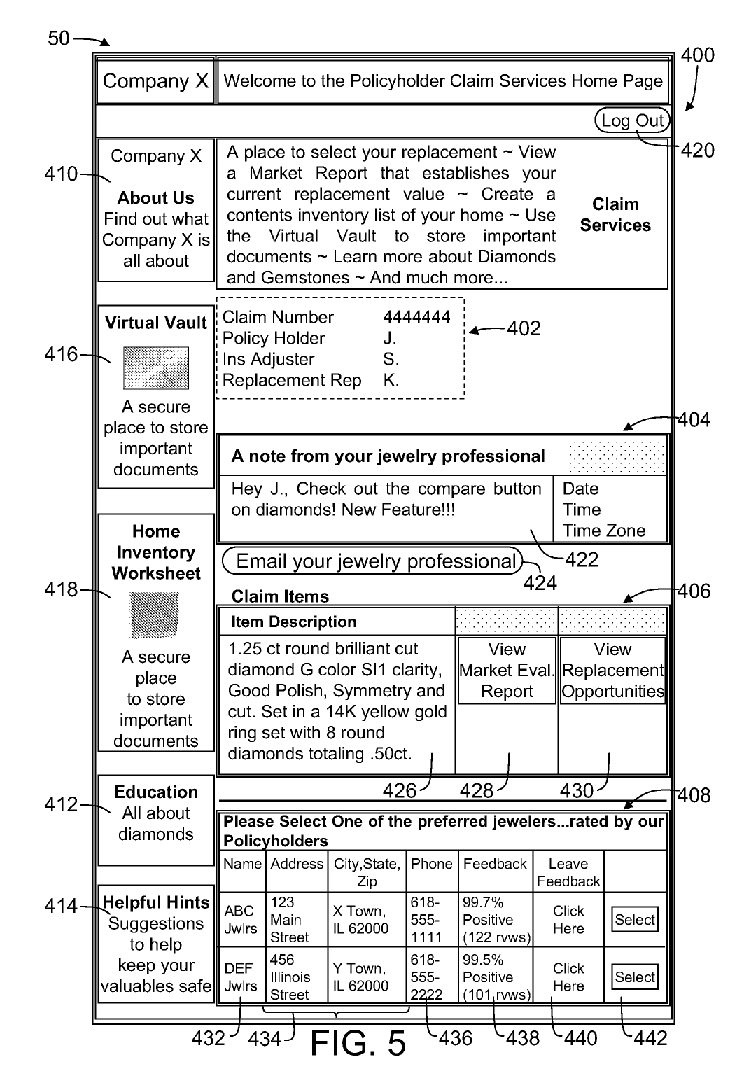

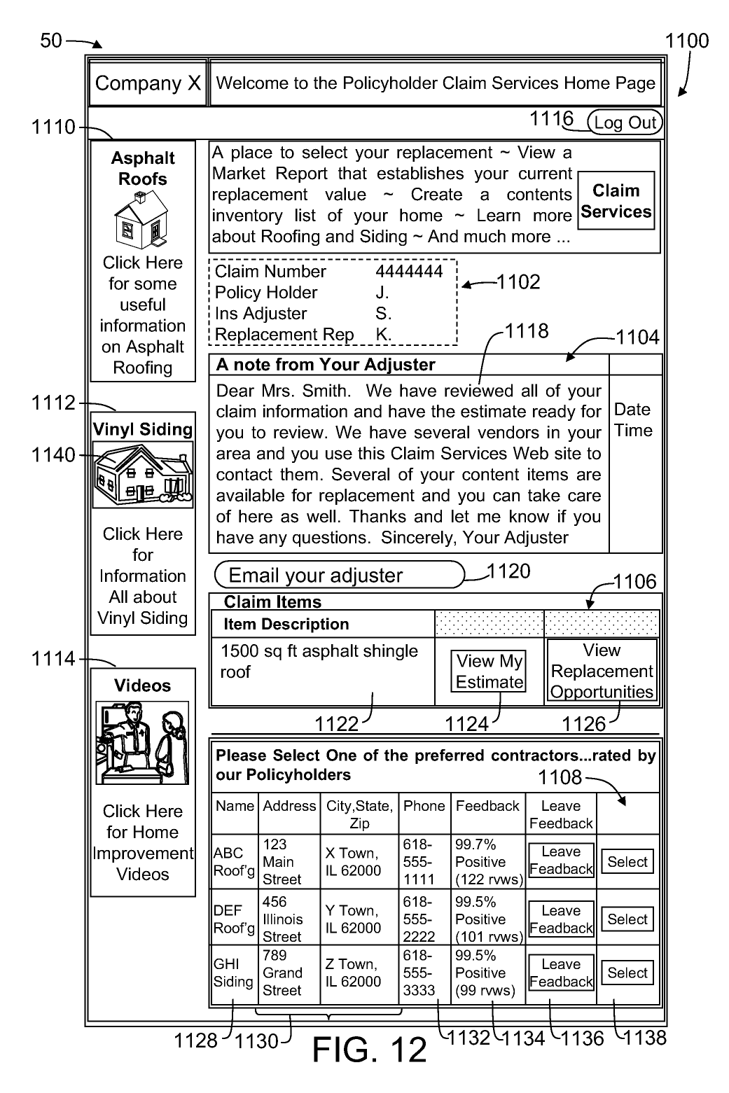

Further, in the exemplary embodiment, the insurance agent and/or the third party representative accesses a list of vendors, such as vendors that are preferred by the insurance company, to provide vendor options for the insured to view through interface 50, for example, using page 400 (shown in FIG. 5) and/or page 1100 (shown in FIG. 12). More specifically, the insurance agent and/or the third party representative enters criteria for selecting vendors, and a database including vendor information is searched for vendors matching and/or substantially matching the entered criteria. The selection criteria may include, for example, but is not limited to including, distance from at least one of a vendor's locations to the location of the insured, specialty, area of expertise, type of products and/or service a vendor provides, at least one review and/or ranking of a vendor, a price of an item and/or a service provided by a vendor, preferred/non-preferred status of a vendor, and/or any other suitable criteria for selecting a vendor. Alternatively, at least one vendor is selected automatically based on the inputted claim and/or insured item description information. In the exemplary embodiment, the at least one selected vendor is stored in the insured's file on server 12 for later access by the insurance agent, the third party representative, and/or the insured.

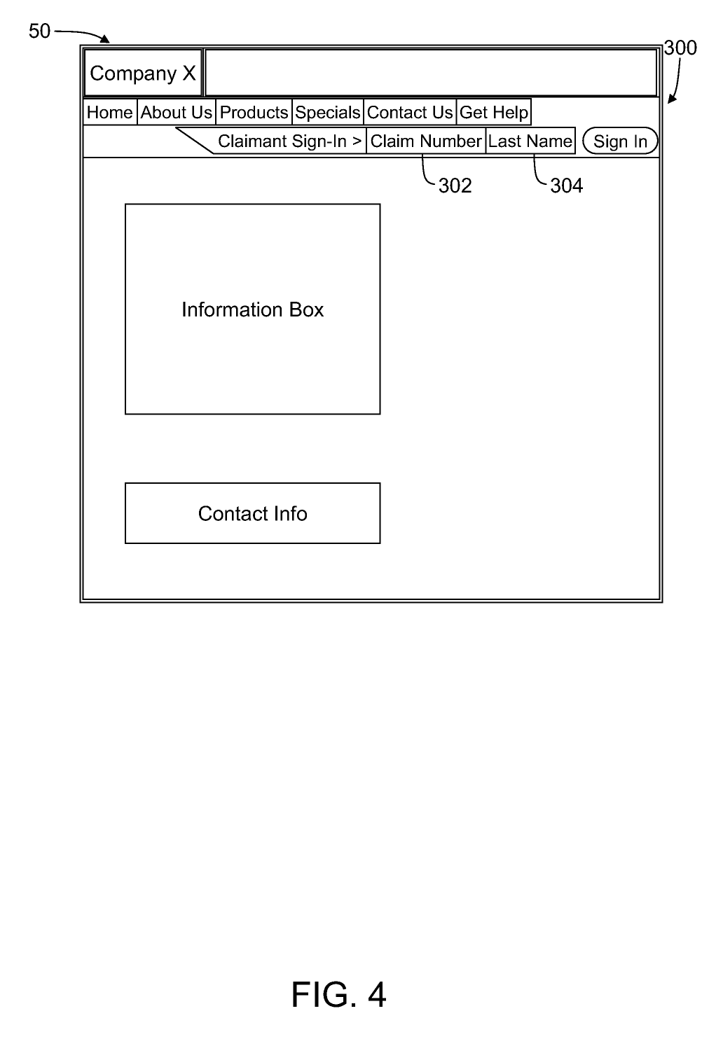

FIGS. 4-13 illustrate exemplary web pages 300, 400, 500, 600, 800, 900, 1000, 1100, and 1200 and a spreadsheet 700 that may be used when navigating through web-based interface 50 of system 10 (shown in FIG. 1). In one exemplary embodiment, web-based interface 50 of system 10 is access via a device 14, 16, and/or 18 (shown in FIG. 1) when method 100 (shown in FIG. 2) is implemented. In the exemplary embodiment, the insured accesses web pages 300, 400, 500, 600, 800, 900, 1000, 1100, and/or 1200 and/or spreadsheet 700 via device 14 to navigate web-based interface 50 to perform method 100. Further, by using web pages 300, 400, 500, 600, 700, 800, 900, 1000, 1100, and 1200, the insured accesses the information within the insured's file that the insured is authorized to access.

More specifically, FIG. 4 is an exemplary log-in page 300 that may be downloaded and displayed on device 14 (show in FIG. 1) by server 12 (shown in FIG. 1) when the insured wants to obtain information about a claim, an insured item, and/or available replacement items. Page 300 includes a first box 302 and a second box 304 in which the insured enters identifying information for logging into subsequent web pages of interface 50. In the exemplary embodiment, the insured logs in by entering a claim number in first box 302 and a last name associated with the claim number in second box 304. Alternatively, the insured logs in using any suitable identifying information, such as an assigned user name and/or password, a selected user name and/or password, a phone number, an address, and/or an email address. In the exemplary embodiment, if the information entered by the insured in boxes 302 and 304 is verified, the insured is given access to database 20 (shown in FIG. 1) and to the information in the insured's file through interface 50.

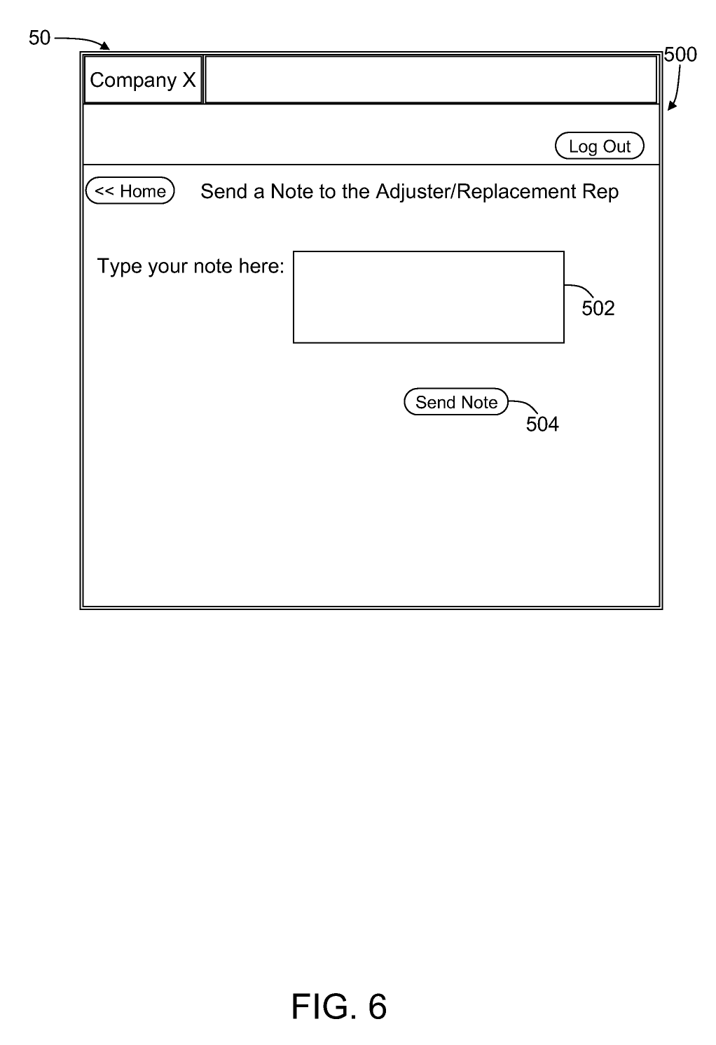

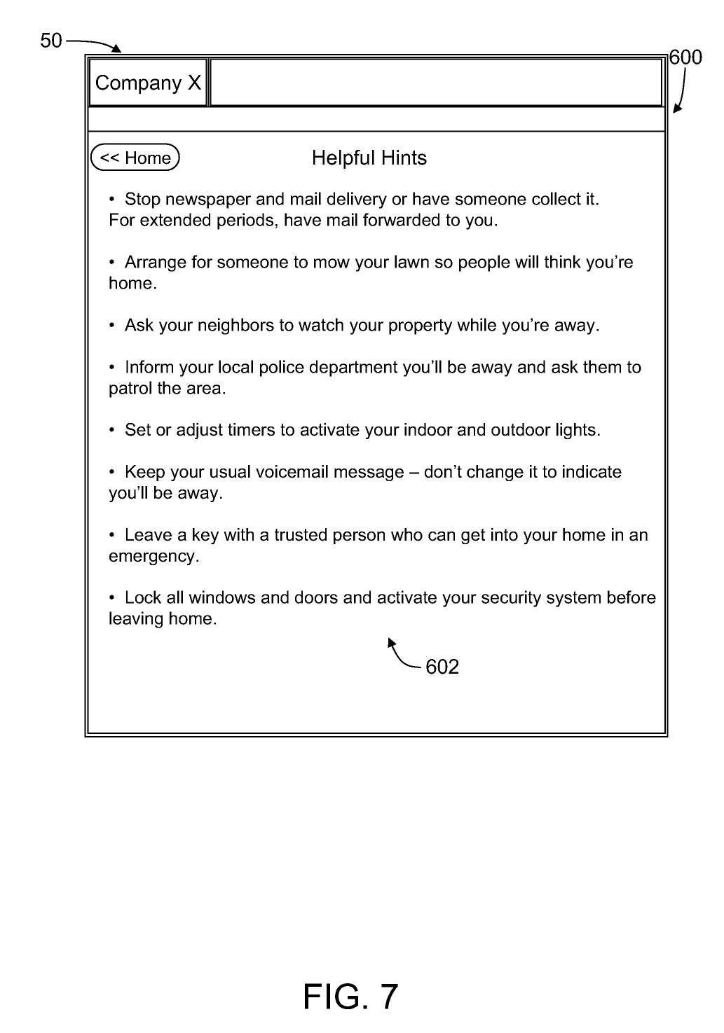

FIG. 5 is an exemplary insured home page 400 that may be downloaded and displayed on device 14 (shown in FIG. 1) by server 12 (shown in FIG. 1) after the insured is logged in. FIG. 6 is an exemplary communication page 500 that may be downloaded and displayed on device 14 by server 12. FIG. 7 is an exemplary hints page 600 that may be downloaded and displayed on device 14 by server 12.

In the exemplary embodiment, home page 400 includes a claim information region 402, a note box 404, a claim items box 406, a vendor box 408, a plurality of informational links 410, 412, and 414, a “Virtual Vault” link 416, an “Inventory” link 418, and a “Log Out” link 420. Alternatively, home page 400 includes more or less than three informational links 410, 412, and/or 414, as described above with respect to page 200 (shown in FIG. 3). In an alternative embodiment, home page 400 does not includes “Virtual Vault” link 416 and/or and “Inventory” link 418, as described above. In still another alternative embodiment, home page 400 includes the following information, and/or links to the following information: timelines and/or flowcharts for repair/replacement, designated parties for completing tasks during repair/replacement, a status of the claim, an estimated time for completion of repair/replacement, a listing of amounts paid out and/or to be paid out to each party for repair/replacement, digital copies of documents, receipts, checks, communications, and/or estimates related to the claim, a log of completed and/or uncompleted repair/replacement tasks, and/or any other suitable information.

In the exemplary embodiment, claim information region 402 includes the claim number, the name of the policy holder, the name of the insurance agent, and the name of the third party representative. Alternatively, claim information region 402 includes any suitable information related to the claim. In the exemplary embodiment, note box 404 includes notes 422 from the insurance agent and/or the third party representative to the insured with the date the note was submitted. The notes are submitted using, for example page 200. The insured can communicate with the insurance agent and/or the third party representative by selecting a correspondence button 424. Although button 424 includes the title “Email Your Jewelry Professional,” button 424 may include any suitable title, such as “contact us,” “email your adjuster” (shown in FIG. 12), “email your replacement professional,” “leave a message,” etc. In the exemplary embodiment, button 424 links the insured to communication page 500, as shown in FIG. 6. Communication page 500 includes a text box 502 in which the insured inputs the text of a message and a “Send” button 504 that submits the entered message to system 10. More specifically, the entered message is stored within the insured's file on server 12 for access by the insurance agent, the third party representative, and/or the insured. As such, communication page 500 allows the insured to submit a message to the insurance agent and/or the third party representative. Referring again to FIG. 5, notes submitted to the insurance agent and/or the third party representative may or may not be displayed on home page 400 in note box 404 with the notes from the insurance agent and/or the third party representative.

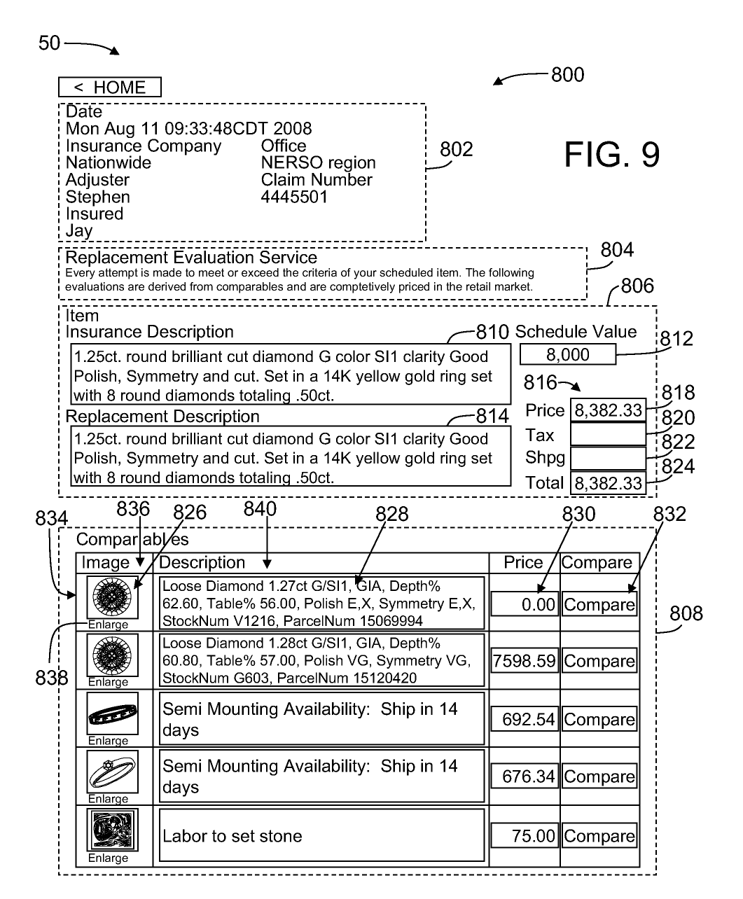

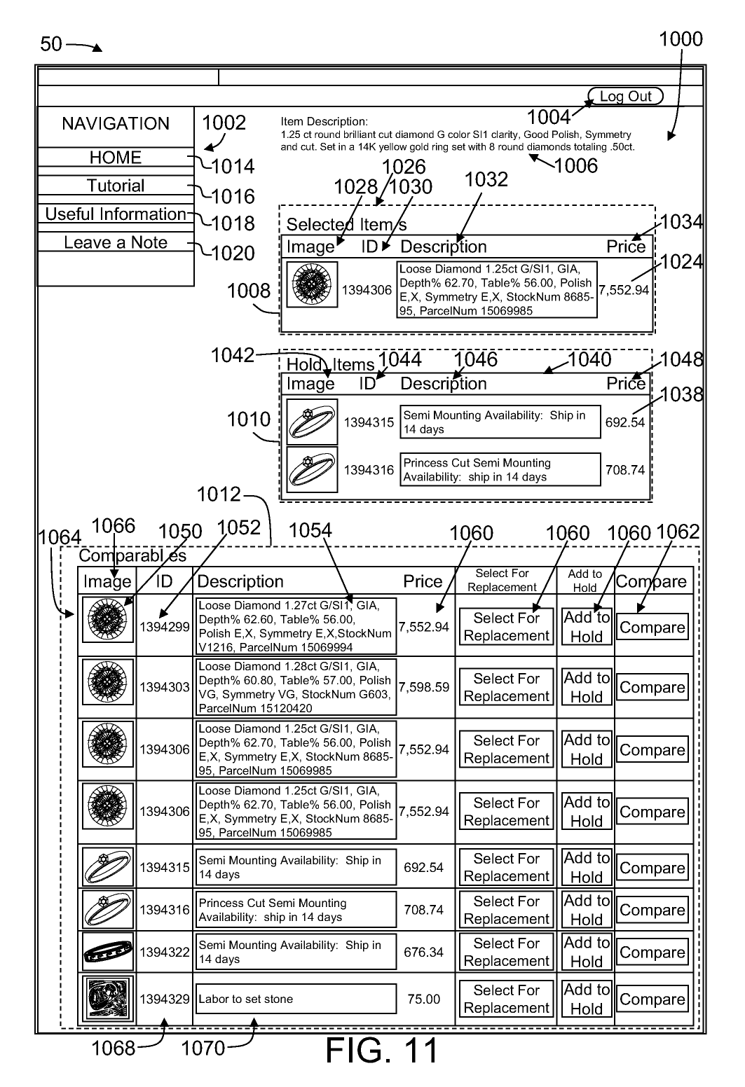

Claim items box 406, in the exemplary embodiment, includes information inputted 104 (shown in FIG. 2) about the insured item. More specifically, claim items box 406 includes an item description 426 of the insured item, an “MER” button 428, and a “Replacement” button 430. In the exemplary embodiment, “MER” button 428 is linked to an MER page 800 (shown in FIG. 9), described in more detail below, and “Replacement” button 430 is linked to a Comparables page 1000 (shown in FIG. 11), described in more detail below.

In the exemplary embodiment, and referring to FIG. 5, vendor box 408 includes information relating to insurance company preferred vendors. Alternatively, vendor box 408 includes preferred and/or non-preferred vendors. More specifically, in the exemplary embodiment, the vendors listed in vendor box 408 are selected as described above. For example, in the exemplary embodiment, the vendors are selected based on a pre-stored list of preferred vendors and the insured's location, as determined using any suitable location indicating information, such as zip code, area code, phone number, address, and/or county. More specifically, in the exemplary embodiment, preferred vendors in and/or near the insured's zip code and specializing in the field of the insured item are selected for display in vendor box 408. For example, if the insured's claim is for roof damage, pre-stored preferred roofing contractors in and/or within a predetermined range of the insured's zip code are selected for display in vendor box 408. In the exemplary embodiment, for each vendor listed in vendor box 408, vendor box 408 includes a profile link 432, an address 434, a phone number 436, a feedback score 438, a feedback link 440, and a select link 442. Alternatively, vendor box 408 includes any suitable information related to a preferred vendor, such as specialty (especially when several insured items, such as drywall and flooring, are being replaced), an email address, and/or the name of a contact person at the vendor.

In the exemplary embodiment, profile link 432 directs the insured to a web page that provides a profile of the vendor and/or to the vendor's web page such that the insured can obtain more information about each preferred vendor before selecting a vendor. The profile includes text and/or links relating to, for example, a history of the vendor, office locations, references, Better Business Bureau records, hours of business, and/or any other suitable information related to the vendor. The vendor profile may be entered by the vendor, the third party representative, the insurance agent, and/or any other suitable party. Address 434 provides a vendor's location that is nearest to the insured's location and is text and/or a link to more information related to the address, such as multiple locations, distance from the insured, and/or a map to the displayed address. Phone number 436 is a phone number at which the vendor can be contacted and is text and/or a link to more information related to the phone number, such as multiple phone numbers, time zone, and/or international calling codes.

Feedback score 438 provides information relating to a score the vendor has received based on other insureds' reviews of the vendor. The score is displayed in text of a hyperlink and links the insured to reviews of the vendor that were submitted by other insureds. In the exemplary embodiment, the score is a percentage based on 100% being perfect, however, it will be understood that any type of indication may be used as the score. For example, a score may be a number based on a range of 1-10, a number of stars, a pictorial representation, a numerical indicator, a scale, and/or any other suitable score indicating text and/or graphics. In the exemplary embodiment, feedback score 438 includes a textual display of how many reviews the score is based on. In an alternative embodiment, feedback score 438 does not include the number of reviews the score is based on. In the exemplary embodiment, feedback link 440 directs the insured to a web page that enables the insured to enter textual comments about a vendor and/or enter a score, for example, a score based on predetermined criteria. In one embodiment, the insured enters the score by selecting checkboxes for a series of questions. In another embodiment, the insured enters a numeric score. Alternatively, the insured enters a score using any suitable scoring device and/or convention. In the exemplary embodiment, only preferred vendors receive feedback, however, it will be understood that non-preferred vendors may also receive feedback. Entered feedback is stored within server 12 and the vendor's score is updated to reflect the new review.

In the exemplary embodiment, select link 442 enables the insured to select a vendor from the vendors within vendor box 408. When the insured selects select link 442, the insured is directed to a confirmation website and a notification is sent to the third party representative, the vendor, and/or the insurance company. If the insurance company receives a notification, the insurance company can directly send the claim information to the selected vendor. In the exemplary embodiment, once a vendor has been selected, whether or not the selected vendor is on the preferred vendor list, contact information for the selected vendor is displayed within vendor box 408. When other claims-related information is displayed on home page 400, such as a timeline, task list, and/or budget, the selected vendor is shown as assigned to specific tasks and/or items and/or as designated to receive funds for repair/replacement from the total estimated claim value. It will be understood that the selected vendor can be linked and/or displayed as corresponding to any suitable claim information on home page 400 and/or any other web page described herein.

Informational links 410, 412, and 414 include a third party representative information link 410, a claim specific educational link 412, and a helpful hints link 414. Alternatively, any suitable informational links are displayed on home page 400. In the exemplary embodiment, third party representative information link 410 directs the insured to an “About Us” page. The “About Us” page includes information related to the third party as described herein. For example, the third party is the party that compares the insured item's description to possible replacement items and generates a comparables list for the insured and/or the insurance agent, as described herein. In the exemplary embodiment, the third party is the party which hosts the web pages and interface 50 described herein to facilitate communication between the insured and the insurance company to settle a claim.

In the exemplary embodiment, at least some of the informational links, such as claim specific educational link 412, are selected by the insurance agent using page 200, as described in more detail above. More specifically, claim specific educational link 412 corresponds to the additional information selected by the insurance agent and/or the third party representative, as described above. In the exemplary embodiment, because the claim is related to jewelry, and more specifically, diamonds, claim specific educational link 412 directs the insured to an educational web page that provides more information about diamonds, such as, for example, the Gemological Institute of America's (GIA) website. In the exemplary embodiment, the insured is directed to text, graphics, and/or video that provides more information about the selected related topic. In one embodiment, when the claim is for replacement of multiple items, such as multiple gem stones and at least one setting, home page 400 includes multiple claim specific educational links 412 that are each displayed separately and/or displayed in a drop down menu. Each link 412 is related to an aspect of the claim, such as diamonds, emeralds, sapphires, rings, pendants, jewelry repair, and/or jewelry selection. In another embodiment, claim specific educational link 412 directs the insured to an educational web page including a glossary of industry terms specific to the insured item. As such, the insured can use claim specific educational link 412 to gain more information about how a claim will be repaired and/or replaced and/or more information about the industry with which the insured will be dealing while repairing and/or replacing the insured item.

In the exemplary embodiment, helpful hints link 414 directs the insured to a hints page 600, as shown in FIG. 7, that includes hints 602 related to insurance, claims, and/or keeping valuable possessions safe from damage and/or loss. Hints 602 can be related to the claim and/or be related to insurable items generally. Further, hints 602 can be selected based on the claim and/or generated randomly such that, each time the insured selects helpful hints link 414, hints page 600 includes different hints 602.

Referring again to FIG. 5, “Virtual Vault” link 416, in the exemplary embodiment, directs the insured to an upload/download web page that enables the insured to upload important documents to a database, such as database 20, for safekeeping. More specifically, once the insured has scanned or otherwise made a digital copy of important documents, the insured selects “Virtual Vault” link 416 to be directed to the upload/download web page. At the upload/download web page, the insured selects each scanned document for uploading to the database. If an important document is lost and/or damaged, the insured can access the upload/download web page to download a document that was previously uploaded to the database. For example, the insured makes digital copies of important documents, such as deeds, birth certificates, policies, and/or wills, and uploads the digital copies to the database using “Virtual Vault” link 416. When the insured would like access to the uploaded digital copies, the insured selects “Virtual Vault” link 416 to access a web page that allows digital copies to be downloaded.

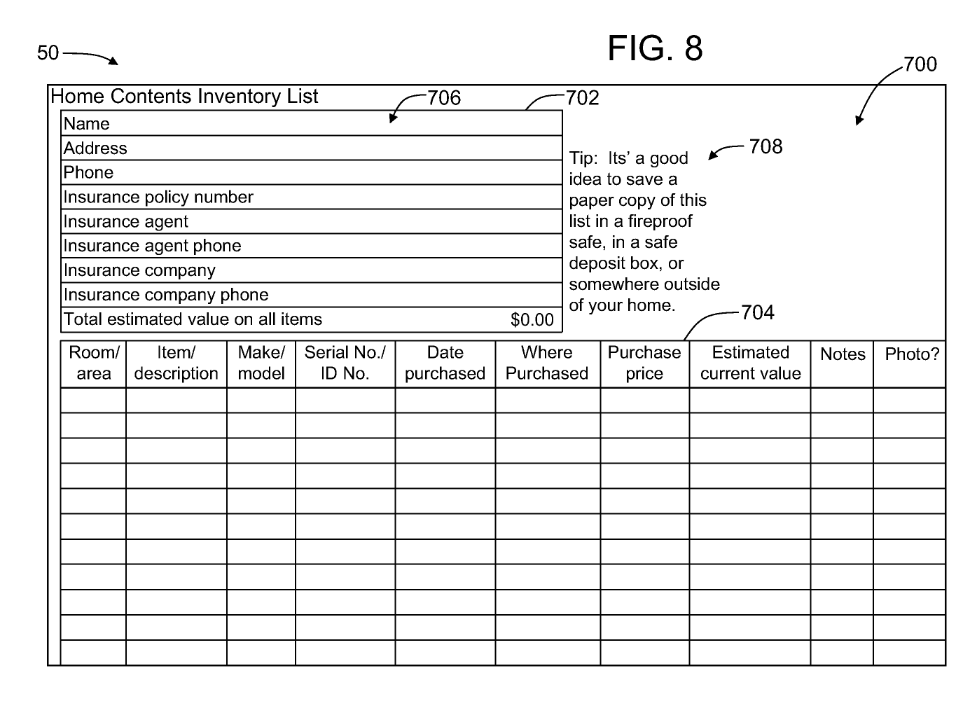

In the exemplary embodiment, “Inventory” link 418 directs the insured to a pre-formatted spreadsheet 700 (shown in FIG. 8). FIG. 8 is an exemplary pre-formatted spreadsheet 700 that is accessible to the insured using system 10 (shown in FIG. 1). More specifically, spreadsheet 700 stored on server 12 (shown in FIG. 1) is automatically downloaded when the insured selects “Inventory” link 418 (shown in FIG. 5). The insured can save a copy of spreadsheet 700, populate spreadsheet offline, and/or alter the predetermined formatting. Alternatively, spreadsheet 700 is an interactive online application that is populated by the insured and saved to a database, such as database 20 (shown in FIG. 1). In the exemplary embodiment, spreadsheet 700 includes an insurance information table 702 and an inventory table 704. Insurance information table 702 includes boxes 706 for entering predetermined information about the insured's insurance policy. Inventory table 704 includes any suitable predetermined headings, such as, “Room/area,” “Item/description,” “Make/model,” “Serial number/ID number,” “Data purchased,” “Where purchased,” “Purchase price,” “Estimated current value,” “Notes,” and/or “Photo?”. Tables 702 and 704 are each configured to allow the insured to enter text and/or numbers relating to an item. Spreadsheet 700 can also include a tip 708, and/or any other helpful information for populating spreadsheet 700. For example, spreadsheet 700 can include help text related to each heading for facilitating populating spreadsheet 700 with the correct information. In an alternative embodiment, spreadsheet 700 includes any suitable fields for making an inventory of the insured's possessions, whether insured or not, and for entering important information for later access by the insured. Referring again to FIG. 5, “Log Out” link 420 enables the insured to securely leave interface 50 to another web page.

FIG. 9 is an exemplary MER page 800 that may be downloaded and displayed on device 14 (shown in FIG. 1) by server 12 (shown in FIG. 1). MER page 800 displays a market evaluation report (“MER”) of items that are comparable to the insured item as determined by the third party representative, the insurance agent, and/or any other suitable party. The insured accesses MER page 800 from home page 400 (shown in FIG. 5) and/or home page 1100 (shown in FIG. 12) as described herein.

In the exemplary embodiment, MER page 800 includes a claim information region 802, a replacement service information region 804, a comparative information region 806, and a comparables list region 808. Claim information region 802 includes information relating to the claim, such as, for example, the current date, the date of the claim, insurance company information, the insurance agent's name, the claim number, and/or the insured's name. The text that appears in claim information region 802 is entered into the insured's file by, for example, the insurance agent and/or the third party representative, and is not alterable by the insured. Replacement service information region 804 includes information related to the replacement and/or repair process, such as, for example, information about how the comparable items were selected. The text that appears in replacement service information region 804 is entered into the insured's file by, for example, the insurance agent and/or the third party representative, and is not alterable by the insured.

Comparative information region 806 includes an insured item description field 810, an insured item scheduled value field 812, a replacement item description field 814, and a replacement item price field 816. Fields 810, 812, 814, and 816 includes text that is entered into the insured's file by, for example, the insurance agent and/or the third party representative, and is not alterable by the insured. More specifically, in the exemplary embodiment, insured item description field 810 includes text of the inputted insured item specification information for the insured item. Insured item scheduled value field 812 includes the scheduled value of the insured item, which is the value that the insured item was insured for under an insurance policy. Alternatively, the scheduled value may reflect any suitably assigned value of the insured item. In the exemplary embodiment, replacement item description field 814 includes text of a description of the comparable item that is most similar to the insured item, based on the features of the comparable item and the features of the insured item. Such a comparable item is considered a “replacement item” with respect to MER page 800. The replacement item may be an assembly of comparable items and/or a single comparable item. In the exemplary embodiment, the replacement item is an assembly of comparable items that is most similar to the insured item. The description of the replacement item is retrieved from a database and uploaded to MER page 800 when MER page 800 is accessed. Further, in the exemplary embodiment, price field 816 includes a price box 818, a tax box 820, a shipping box 822, and a total price box 824. Values within boxes 818, 820, 822, and/or 824 are predetermined based on the pre-stored information related to the replacement item and/or pre-stored information, such as tax rates and/or shipping rates, in an accessible database.

Comparables list region 808 includes at least one comparable item that may be used as the replacement item. For example, when a diamond ring is the insured item, comparables list region 808 includes a list a comparable items for the diamond, the ring setting, and/or the labor for setting a replacement diamond in a replacement setting. Comparables list region 808, in the exemplary embodiment, includes a listing having representative examples of all of the comparable items found that substantially match the insured item. Alternatively, comparables list region 808 includes a list of all the comparable items found. In the exemplary embodiment, for each comparable item within comparable list region 808, list region 808 includes an image 826, a description 828, a price 830, and a “Compare” button 832. Further, each comparable item has a respective row 834 within list region 808 to display corresponding image 826, description 828, price 830, and “Compare” button 832.

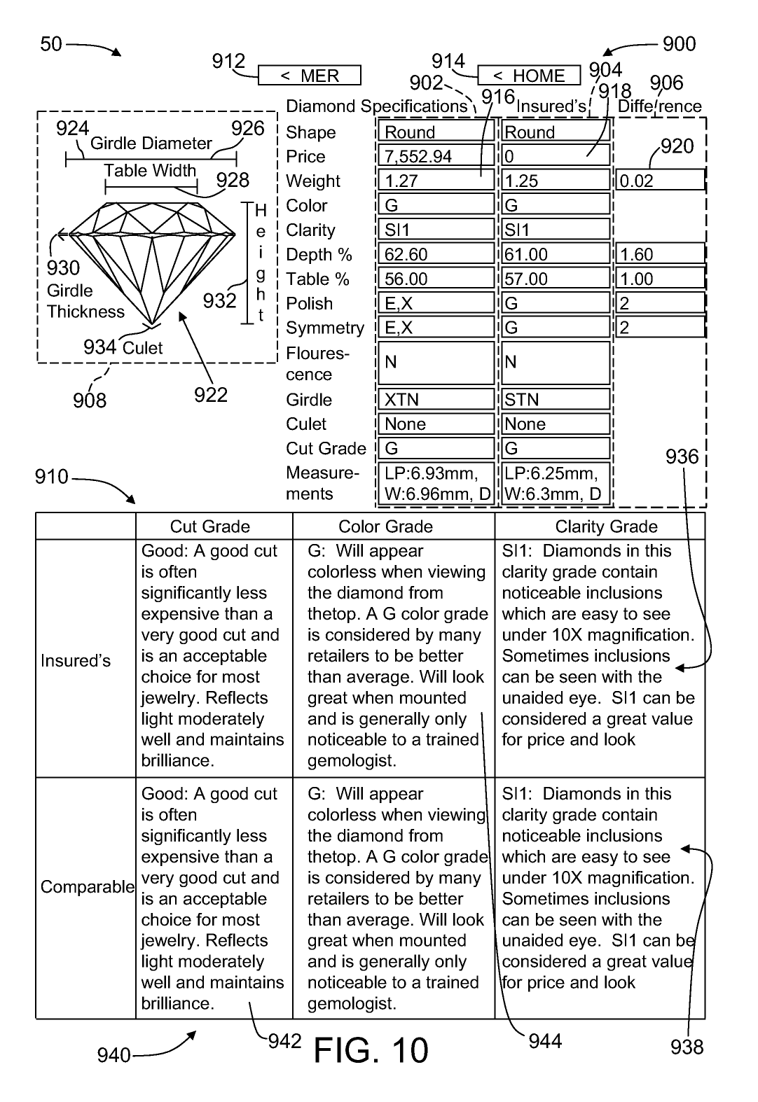

More specifically, in the exemplary embodiment, if an image of the comparable item is available, image 826, preferably resized from an original image, is displayed within an image column 836 of list region 808. Adjacent each image 826, an “Enlarge” link 838 allows a user to view an enlarged image of image 826 by being directed to an original image web page. If an image 826 is not available from a comparable item, “Enlarge” link 838 is disabled. Further, description 828 of each comparable item is textually displayed within a description column 840 of list region 808. Description 828 of each comparable item is retrieved from a database and uploaded to MER page 800 when MER page 800 is accessed. Price 830 of each comparable item is a real-time price of the comparable item as retrieved from a suitable database when MER page 800 is accessed. Alternatively, price 830 is a price that is fixed at a predetermined time. In the exemplary embodiment, “Compare” button 832 is a link that directs the insured to a comparison page, such as comparison page 900 (shown in FIG. 10), that compares the respective comparable item to the insured item.

FIG. 10 is an exemplary comparison page 900 that may be downloaded and displayed on device 14 (shown in FIG. 1) by server 12 (shown in FIG. 1). Comparison page 900 displays a feature-by-feature comparison of a comparable item to the insured item. More specifically, comparison page 900 includes a comparable item description region 902, an insured item description region 904, a differences region 906, a graphic informational field 908, and a textual informational field 910. Alternatively, comparison page may includes more or less than one graphic informational field 908 and/or textual informational field 910. In the exemplary embodiment, page 900 also include MER button 912 and Home button 914 for returning to subsequent pages 800 (shown in FIG. 9) and 400 (shown in FIG. 5) and/or 1100 (shown in FIG. 12).

In the exemplary embodiment, comparable item description region 902 includes a plurality of specification fields 916 that are automatically populated using pre-stored data relating to the comparable item. Such data may be retrieved from any suitable database to automatically populate fields 916. In the exemplary embodiment, which is a claim for a diamond ring, fields 916 are related to specifications of a comparable diamond. For example, fields 916 includes fields for specifications, such as shape, price, weight, color, clarity, depth %, table %, polish, symmetry, fluorescence, girdle, culet, cut grade, and measurements. In the exemplary embodiment, insured item description region 904 includes a plurality of specification fields 918 that are the same and/or substantially similar to fields 916 of comparable item description region 902 such that the insured can view a side-by-side comparison of each feature of the comparable item and the insured item. It will be understood that fields 916 and/or 918 may be modified depending on the type of loss, the comparable items, and/or the insured item.

Differences region 906 includes a plurality of fields 920 corresponding to fields 916 and/or 918. More specifically, in the exemplary embodiment, when a comparable field 916 differs from an insured field 918, a respective difference field 920 is displayed and includes an indication of the difference between the value in field 916 and the value in field 918. The difference value is automatically determined based on the values of fields 916 and/or 918, and the determined difference value is automatically populated in a corresponding difference field 920. Further, in the exemplary embodiment, when there is no difference between a comparable field 916 and an insured field 918, a difference field 920 is not displayed. Alternatively, when there is no difference between a comparable field 916 and an insured field 918, a difference field 920 indicate that there is no difference by displaying a value, such as “none,” “0,” and/or “N/A.”

In the exemplary embodiment, graphic informational field 908, and/or textual informational field 910 provides additional information related to the comparison. More specifically, in the exemplary embodiment of a diamond, graphic informational field 908 includes a graphic representation 922 of a diamond, including graphic definitions 924 of the specifications being compared. For example, definitions 924 include a dimension 926 defining a girdle diameter, a dimension 928 defining a table width, a dimension 930 defining a girdle thickness, a dimension 932 defining a height, an indication 934 defining a culet, and/or any other suitable dimensions and/or indications related to the specifications of the comparable item and/or the insured item.

Further, in the exemplary embodiment, textual information field 910 includes an insured item row 936 and a comparable item row 938. Each row 936 and 938 is divided in to columns 940 correspond to significant comparison features. Within each cell 942 formed by rows 936 and/or 938 and columns 940, informational text 944 is displayed. Information text 944 includes, for example, but is not limited to including, a specification term and a definition of the specification term. In the exemplary embodiment of a diamond, the significant comparison features are cut grade, color grade, and clarity grade, and informational text 944 includes a specification term, such as good, G, and/or SI1, with a definition of that specification term. It will be understood that graphic informational field 908 and/or textual informational field 910 are modified depending on the type of claim, the comparable items, and/or the insured item and can include as many and/or as few terms and/or definitions as desired.

In an alternative embodiment, when the insurance claim is for a real property loss including contents of the real property, fields 916, 918, and/or 920 are related to specifications for at least one comparable item for each content item lost. For example, when the contents of the real property includes a computer and a microwave, list region 808 (shown in FIG. 9) includes computers that are comparable to the insured computer and microwaves that are comparable to the insured microwave. When, for example, a comparable computer is selected using “Compare” button 832 (shown in FIG. 9), comparison page 900 displays a feature-by-feature comparison between the comparable computer and the insured computer. In this case, fields 916 and/or 918 include fields for computer specifications, such as price, make, model, manufacturer, RAM, hard drive capacity, processor speed, size, adapters, mouse, display, keyboard, ports, optical drive, and/or hardware devices. If, for example, the insured item is no longer available, computers having comparable features will be listed within list region 808, and comparison page 900 will display a feature-by-feature comparison between the available comparable computer and the unavailable insured computer. Accordingly, in the exemplary embodiment, fields 916 and/or 918 can be modified depending on the insured item and/or comparable items.

Further, in the case where comparison page 900 displays computers, graphic informational field 908 can graphically display a computer with computer specifications term graphically define with respect to the computer graphic. Further, textual informational field 910 can include informational text 944 related to computer specifications that are significant comparison features, such as, processor speed, hard drive capacity, optical drive, and/or memory. Accordingly, in the exemplary embodiment, fields 916, 918, and/or 920 can be modified to provide information to the insured to assistant the insured in making a replacement decision.

FIG. 11 is an exemplary Comparables page 1000 that may be downloaded and displayed on device 14 (shown in FIG. 1) by server 12 (shown in FIG. 1). Comparables page 1000 includes a links section 1002, a log out link 1004, an insured item description section 1006, a selected items region 1008, a hold items region 1010, and a comparable items region 1012.

Link section 1002 includes, in the exemplary embodiment, a plurality of links, such as a home link 1014, a tutorial link 1016, an information link 1018, and a note link 1020. Alternatively, link section 1002 includes any suitable links for navigating interface 50. In an alternative embodiment, pages 400, 500, 600, 700, 800, 900, 1100, and/or 1200 (shown in FIGS. 5-10, 12, and/or 13) includes a link section that is similar to link section 1002 and/or a link section that includes links that are different than links 1014, 1016, 1018, and/or 1020. In the exemplary embodiment, home link 1014 directs a user to home page 400 or 1100, tutorial link 1016 directs the used to a tutorial web page that includes information for using interface 50, information link 1018 directs the user to an informational web page, such as the “About Us” web page and/or the educational web page, and note link 1020 directs the user to communication page 500. Further, in the exemplary embodiment, log out link 1004 enables the insured to securely leave interface 50 to another web page. Insured item description section 1006 includes text of the inputted insured item specification information. In the exemplary embodiment, the text in insured item description section 1006 is retrieved from the insured's file and is not alterable by the insured.

In the exemplary embodiment, selected items region 1008 includes a row 1022 for each comparable item selected by the insured and/or the insurance agent as a replacement for the insured item. More specifically, each row 1022 is divided into a plurality of a cells 1024 based of a number of columns 1026 within region 1008. More specifically, each column 1026 includes specification information for the comparable item(s) within region 1008. In the exemplary embodiment, columns 1026 includes an image column 1028, an identification column 1030, a description column 1032, and a price column 1034. Alternatively, columns 1026 may include other than columns 1028, 1030, 1032,and/or 1034. In the exemplary embodiment, each cell 1024 is automatically populated with information stored on server 12. If no comparable items have been selected as replacement items, one row 1022 is displayed indicating that no items have been selected and/or found. The insurance agent and/or the third party representative can remove a comparable item from selected items regions 1008 if approved by the insurance company and/or other suitable party. In an alternative embodiment, a comparable item may be removed by the insured using a “Remove” button for a respective row 1022.

In the exemplary embodiment, hold items region 1010 includes a row 1036 for each comparable item selected by the insured and/or the insurance agent as a possible replacement for the insured item. More specifically, each row 1036 is divided into a plurality of a cells 1038 based of a number of columns 1040 within region 1010. More specifically, each column 1040 includes specification information for the comparable item(s) within region 1010. In the exemplary embodiment, columns 1040 includes an image column 1042, an identification column 1044, a description column 1046, and a price column 1048. Alternatively, columns 1040 may include other than columns 1042, 1044, 1046,and/or 1048. In the exemplary embodiment, each cell 1038 is automatically populated with information stored on server 12. If no comparable items have been selected as possible replacement items to hold, one row 1036 is displayed indicating that no items have been selected and/or found. Each item in hold items region 1010 is stored in the insured's file and submitted for review to the insurance agent and/or the third party representative for a determination whether the held comparable item is a suitable like-kind replacement for the insured item. The insurance agent and/or the third party representative can remove a comparable item from hold items regions 1010 if approved by the insurance company and/or other suitable party. In an alternative embodiment, a comparable item may be removed by the insured using a “Remove” button for a respective row 1036.

In the exemplary embodiment, comparable items region 1012 includes at least one comparable item that may be used as the replacement item. For example, when a diamond ring is the insured item, comparable items region 1012 includes a list a comparable items for the diamond, the ring setting, and/or the labor for setting a replacement diamond in a replacement setting. Comparable items region 1012, in the exemplary embodiment, includes all of the comparable items found that substantially match the insured item. Alternatively, comparable items region 1012 includes a selection of the most similar, pre-approved, closest in price to the schedule prices, and/or any suitable sub-set of all of the comparable items found. In the exemplary embodiment, for each comparable item within comparable items region 1012, region 1012 includes an image 1050, an identifier 1052, a description 1054, a price 1056, a “Select” button 1058, a “Hold” button 1060, and a “Compare” button 1062. Further, each comparable item is described in a respective row 1064 within region 1012 to display a corresponding image 1050, identifier 1052, description 1054, price 1056, “Select” button 1058, “Hold” button 1060, and “Compare” button 1062.

More specifically, in the exemplary embodiment, if an image of the comparable item is available, image 1050, preferably resized from an original image, is displayed within an image column 1066 of region 1012. Adjacent each image 1050, an “Enlarge” link may be included to allow a user to view an enlarged image of image 1050 by being directed to an original image web page. If an image 1050 is not available from a comparable item, an indication that no image is available is displaced in image column 1066. Further, identifier 1052 is displayed in an identification column 1068 of region 1012. Identifier 1052 is any suitable text, number, and/or graphic that is used to identifier which product in an inventory is being described and/or shown in row 1064. In the exemplary embodiment, identifier 1052 is a number assigned to a particular comparable item to facilitate properly identifying the comparable item within an inventory of items.

Description 1054 of each comparable item is textually displayed within a description column 1070 of region 1012. Description 1054 of each comparable item is retrieved from a database and uploaded to page 1000 when page 1000 is accessed. Price 1056 of each comparable item is a real-time price of the comparable item as retrieved from a suitable database when page 1000 is accessed. Alternatively, price 1056 is a price that is fixed at a predetermined time. In the exemplary embodiment, “Select” button 1058 allows the insured to select which comparable item is to be used as a replacement item for the insured item. By choosing “Select” button 1058 within a row 1064 corresponding to a selected item, the selected item is displayed within selected items region 1008. In the exemplary embodiment, once a comparable item is selected, “Select” button 1058 corresponding to that comparable item is disabled. Alternatively, “Select” button 1058 may remain active after the corresponding comparable item has been selected by the insured.

In the exemplary embodiment, “Hold” button 1060 allows the insured to select which comparable item may be used as a possible replacement item for the insured item. By choosing “Hold” button 1060 within row 1064 corresponding to a desired hold item, the desired hold item is displayed within hold items region 1010. In the exemplary embodiment, once a comparable item is selected to be held, “Hold” button 1060 corresponding to that comparable item is disabled. Alternatively, “Hold” button 1060 may remain active after the corresponding comparable item has been selected by the insured. In the exemplary embodiment, although the insured has selected a comparable item as a replacement item using “Select” button 1058 and/or as a possible replacement item using “Hold” button 1060, the selected and/or held comparable item may require further review by the insurance agent and/or the third party representative before the comparable item is sent to the insured as the replacement. In one embodiment, once a held item has been verified as being a like-kind replacement for the insured item, the held item is moved to selected items region 1008 and is considered to be a selected item for replacing the insured item. In the exemplary embodiment, “Compare” button 1062 is a link that directs the insured to a comparison page, such as comparison page 900 (shown in FIG. 10), that compares the respective comparable item to the insured item such that the insured is able to compare the features of a comparable items with the features of the insured item.

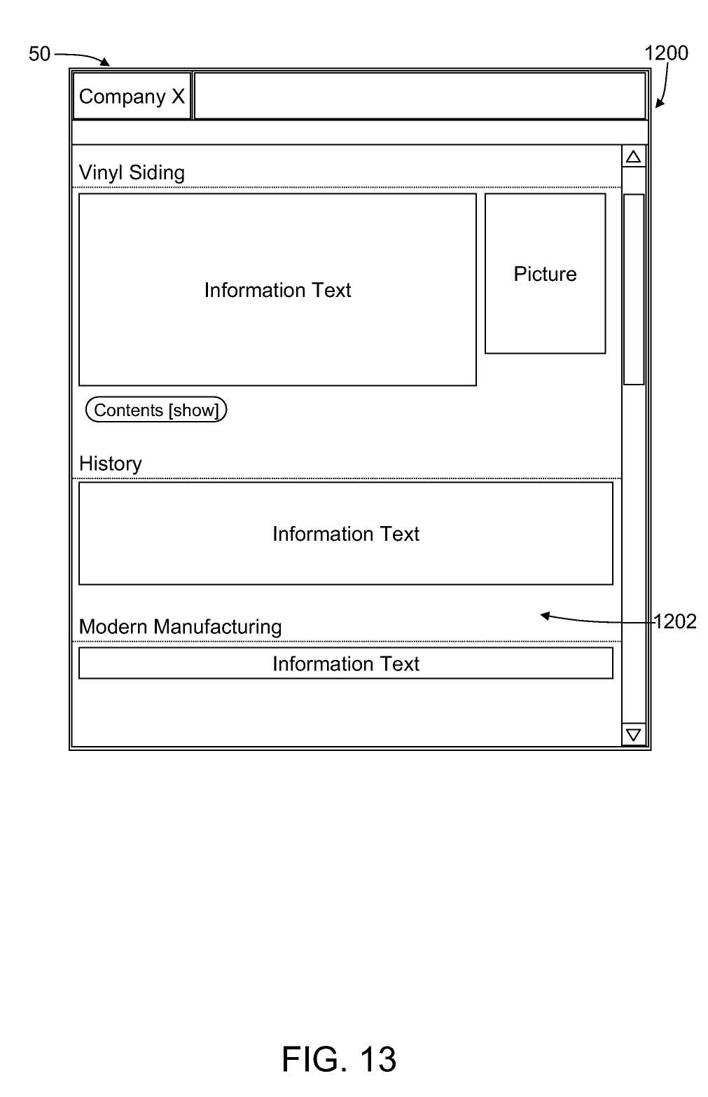

FIG. 12 is an alternative insured home page 1100 that may be downloaded and displayed on device 14 by server 12. FIG. 13 is an exemplary educational page 1200 that may be linked to page 1100.

In the exemplary embodiment, home page 1100 includes a claim information region 1102, a note box 1104, a claim items box 1106, a vendor box 1108, a plurality of informational links 1110, 1112, and 1114, and a “Log Out” link 1116. Alternatively, home page 1100 may alternatively and/or additional include “Virtual Vault” link 416 (shown in FIG. 5) and/or “Inventory” link 418 (shown in FIG. 5). and. Alternatively, home page 1100 includes more or less than three informational links 1110, 1112, and 1114, as described above. In still another alternative embodiment, home page 1100 includes the following information, and/or links to the following information: timelines and/or flowcharts for repair/replacement, designated parties for completing tasks during repair/replacement, a status of the claim, an estimated time for completion of repair/replacement, a listing of amounts paid out and/or to be paid out to each party for repair/replacement, digital copies of documents, receipts, checks, communications, and/or estimates related to the claim, a log of completed and/or uncompleted repair/replacement tasks, and/or any other suitable information.

In the exemplary embodiment, claim information region 1102 includes the claim number, the name of the policy holder, the name of the insurance agent, and the name of the third party representative. Alternatively, claim information region 1102 includes any suitable information related to the claim. In the exemplary embodiment, note box 1104 includes notes 1118 from the insurance agent and/or the third party representative to the insured with the date and/or time note 1118 was submitted. Notes 1118 are submitted using, for example page 200 (shown in FIG. 3). The insured can communicate with the insurance agent and/or the third party representative by selecting a correspondence button 1120. Although button 1120 includes the title “Email Your Adjuster,” button 1120 may include any suitable title, such as “contact us,” “email your replacement professional,” “leave a message,” etc. In the exemplary embodiment, button 1120 links the insured to communication page 500, as shown in FIG. 6 and described above. Notes submitted to the insurance agent and/or the third party representative may or may not be displayed on home page 1100 in note box 1104 with the notes from the insurance agent and/or the third party representative.

Claim items box 1106, in the exemplary embodiment, includes inputted information about the insured item. More specifically, claim items box 1106 includes an item description 1122 of the insured item, an “Estimate” button 1124, and a “Replacement” button 1126. In the exemplary embodiment, “Estimate” button 1124 is linked to MER page 800 (shown in FIG. 9) and/or an uploaded and/or imported electronic file of an estimate. “Replacement” button 1126 is linked to a Comparables page, such as Comparables page 1000 as shown in FIG. 11 and described above. In the exemplary embodiment, the Comparables page lists items, such as, for example, replacement contents for insured contents within an insured real property, that are available for immediate selection as replacement items.

For example, if the insurance claim is for roof damage and for the contents of a room under the damaged part of the roof, the Comparables page includes a list of replacement items for those items that were damaged in the room. More specifically, if a computer, a bed, and a bookcase were in the room and were damaged, the Comparables page includes computers, beds, and/or bookcases that are suitable replacements for the insured items, based on the features of the comparable items and the features of the insured items. The comparable items on the list may be pre-approved and/or supplied by preferred vendors, such that the insured can select a comparable item as a replacement item and have the comparable item sent directly to an address specified by the insured. In one embodiment, the selected comparable items appear is a “shopping cart” and shows the total value of the replacement items. Further, the “shopping cart” may display the remaining balance of the claim amount after the comparable items are selected. Alternatively, the selected may be displayed in any suitable manner, such as, for example, in a selected items region, such as region 1008 (shown in FIG. 11). As such, the insured is able to immediately replace at least some of the insured contents by selecting “Replacement” button 1126.

In the exemplary embodiment, vendor box 1108 includes information relating to insurance company preferred vendors. Alternatively, vendor box 1108 includes preferred and/or non-preferred vendors. More specifically, in the exemplary embodiment, the vendors listed in vendor box 1108 are selected as described above. For example, in the exemplary embodiment, the vendors are selected based on a pre-stored list of preferred vendors and the insured's location, as determined using any suitable location indicating information, such as zip code, area code, phone number, address, and/or county. More specifically, in the exemplary embodiment, preferred vendors in and/or near the insured's zip code and specializing in the field of the insured item are selected for display in vendor box 1108. For example, in the exemplary embodiment, the insured's claim is for roof and siding damage, pre-stored preferred roofing and/or siding contractors in and/or within a predetermined range of the insured's zip code are selected for display in vendor box 1108. In the exemplary embodiment, for each vendor listed in vendor box 1108, vendor box 1108 includes a profile link 1128, an address 1130, a phone number 1132, a feedback score 1134, a feedback link 1136, and a select link 1138. Alternatively, vendor box 1108 includes any suitable information related to a preferred vendor, such as specialty, an email address, and/or the name of a contact person at the vendor.

In the exemplary embodiment, profile link 1128 directs the insured to a web page that provides a profile of the vendor and/or to the vendor's web page such that the insured can obtain more information about each preferred vendor before selecting a vendor. The profile includes text and/or links relating to, for example, a history of the vendor, office locations, references, Better Business Bureau records, hours of business, and/or any other suitable information related to the vendor. The vendor profile may be entered by the vendor, the third party representative, the insurance agent, and/or any other suitable party. Address 1130 provides a vendor's location that is nearest to the insured's location and is text and/or a link to more information related to the address, such as multiple locations, distance from the insured, and/or a map to the displayed address. Phone number 1132 is a phone number at which the vendor can be contacted and is text and/or a link to more information related to the phone number, such as multiple phone numbers, time zone, and/or international calling codes.

Feedback score 1134 provides information relating to a score the vendor has received based on other insureds' reviews of the vendor. The score is displayed in text of a hyperlink and links the insured to reviews of the vendor that were submitted by other insureds. In the exemplary embodiment, the score is a percentage based on 100% being perfect, however, it will be understood that any type of indication may be used as the score. For example, a score may be a number based on a range of 1-10, a number of stars, a pictorial representation, a numerical indicator, a scale, and/or any other suitable score indicating text and/or graphics. In the exemplary embodiment, feedback score 1134 includes a textual display of how many reviews the score is based on. In an alternative embodiment, feedback score 1134 does not include the number of reviews the score is based on. In the exemplary embodiment, feedback link 1136 directs the insured to a web page that enables the insured to enter textual comments about a vendor and/or enter a score, for example, a score based on predetermined criteria. In one embodiment, the insured enters the score by selecting checkboxes for a series of questions. In another embodiment, the insured enters a numeric score. Alternatively, the insured enters a score using any suitable scoring device and/or convention. In the exemplary embodiment, only preferred vendors receive feedback, however, it will be understood that non-preferred vendors may also receive feedback. Entered feedback is stored within server 12 and the vendor's score is updated to reflect the new review.

In the exemplary embodiment, select link 1138 enables the insured to select a vendor from the vendors within vendor box 1108. When the insured selects select link 1138, the insured is directed to a confirmation website and a notification is sent to the third party representative, the vendor, and/or the insurance company. If the insurance company receives a notification, the insurance company can directly send the claim information to the selected vendor. In the exemplary embodiment, once a vendor has been selected, whether or not the selected vendor is on the preferred vendor list, contact information for the selected vendor is displayed within vendor box 1108. When other claims-related information is displayed on home page 1100, such as a timeline, task list, and/or budget, the selected vendor is shown as assigned to specific tasks and/or items and/or as designated to receive funds for repair/replacement from the total estimated claim value. It will be understood that the selected vendor can be linked and/or displayed as corresponding to any suitable claim information on home page 1100 and/or any other web page described herein.

Informational links 1110, 1112, and/or 1114 are a claim specific educational links. Alternatively, any suitable informational links are displayed on home page 1100. In the exemplary embodiment, the claim specific educational links 1110, 1112, and/or 1114 are selected by the insurance agent using page 200 (shown in FIG. 3), as described in more detail above, and/or by the third party representative. More specifically, claim specific educational links 1140correspond to the additional information selected by the insurance agent and/or the third party representative, as described above. In the exemplary embodiment, because the claim is related to a real property loss, and more specifically, roofing and siding, claim specific educational links 1140 direct the insured to an educational web page, such as educational web page 1200, that provides more information about, for example, roofing, siding, and/or general home repairs. In the exemplary embodiment, the insured is directed to text, graphics, and/or video that provides more information about the selected related topic. In the embodiment, multiple claim specific educational links 1140 are displayed separately, however, multiple educational links 1140 may be displayed in a drop down menu.

Each link 1140 is related to an aspect of the claim, such as asphalt roofs, wood shingles, metal shingles, tile roofs, slate roofs, vinyl siding, wood siding, brick, aluminum siding, veneer siding, the roofing process, the siding process, and/or home repairs generally. In another embodiment, claim specific educational link 1140 directs the insured to an educational web page including a glossary of industry terms specific to the insured item. As such, the insured can use claim specific educational link 1140 to gain more information about how a claim will be repaired and/or replaced and/or more information about the industry with which the insured will be dealing while repairing and/or replacing the insured item.

When the insured chooses one of links 1140, the insured is directed to an educational web page, such as web page 1200. Web page 1200 includes information 1202, such as text explaining, for example, vinyl siding. Alternatively, web page 1200 includes text, graphics, and/or video that provides information to the insured about the selected topic.

The above-described system and method for replacing an insured item enables an insured to gather relevant information about an insurance claims, replacement items, and/or insured items using a single web-based interface. More specifically, the web-based interface allows at least three parties to share information about an insurance claim, a quote, and/or replacement items such that the insurance claim may be quickly and easily settled, as compared to a process wherein each party communicates individually and messages are relayed between the parties. Further, the embodiments described herein enable an insured to access additional information related to an insurance claim such that insured can become more educated on the claim process, the repair process, the replacement process, the comparable items, the insured item, and/or any other topic related to the insurance claim. As such, processing of the claim is more transparent for the insured. For example, in at least one embodiment described herein, the insured can access all comparable items and information as to why those are the comparable items. Accordingly, the systems and methods described herein facilitate increasing the ease with which a claim a settled while facilitating reducing frustration, confusion, and/or tensions a party to an insurance claim may encounter.

Additionally, the above-described web pages may be customized depending on the requirements of an insurance company and/or based on the type of claim. More specifically, the above-described web pages are exemplary pages for particular types of claims, as modified to meet requirements of the insurance company. The embodiments described herein may includes as little or as much information as desired and/or any type of information that is desired. Accordingly, the web pages described herein can be modified to display any suitable information that facilitates making the insurance claim process and/or related processes more transparent for at least the insured.

Exemplary embodiments of methods and systems for replacing insured items are described above in detail. The methods and systems are not limited to the specific embodiments described herein, but rather, components of systems and/or steps of the methods may be utilized independently and separately from other components and/or steps described herein. For example, the methods may also be used in combination with other communication systems and methods, and are not limited to practice with only the insurance claim systems and methods as described herein. Rather, the exemplary embodiment can be implemented and utilized in connection with many other multiple party communication applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for replacing insured items using a web-based system including a server and at least one device connected to the server via a network, said method comprising:
receiving at the server specification information about an insured item to be replaced, the specification information including at least one feature of the insured item;
comparing the received item specification information with potential replacement product information pre-stored within at least one of the server and a database to identify at least one comparable item that is comparable to the insured item;
compiling a list of the at least one comparable item, the list including specification information related to the at least one comparable item;
displaying the compiled list to at least an insured;
selecting the at least one comparable item for comparison with the insured item; and
displaying a comparison between at least one feature of the at least one comparable item and at least one feature of the insured item.

2. A method in accordance with claim 1 wherein displaying the compiled list to at least an insured further comprises displaying the compiled list including at least one of a real-time price of the at least one comparable item and a real-time availability of the at least one comparable item.

3. A method in accordance with claim 1 wherein displaying a comparison between at least one feature of the at least one comparable item and at least one feature of the insured item further comprises displaying a feature-by-feature comparison between features of the at least one comparable item and features of the insured item.

4. A method in accordance with claim 1 wherein displaying a comparison between at least one feature of the at least one comparable item and at least one feature of the insured item further comprises displaying a definition of the least one feature.

5. A method in accordance with claim 1 further comprising selecting the at least one comparable item to be held as a possible replacement item for the insured item.

6. A method in accordance with claim 1 further comprising:
selecting the at least one comparable item as a replacement item for the insured item; and
providing the replacement item to the insured.

7. A method in accordance with claim 1 further comprising:
selecting at least one educational topic related to an insurance claim for the insured item; and
displaying at least one educational link to the insured, wherein the at least one education link directs the insured to an educational web page related to the at least one selected educational topic.

8. A method in accordance with claim 1 further comprising displaying information related to at least one vendor, wherein the displayed information includes at least one of a vendor name, vendor contact information, a vendor rating, and link to select the at least one vendor.

9. A method in accordance with claim 1 further comprising storing at least one digital copy a document on the server.

10. A method in accordance with claim 1 further comprising accessing a pre-formatted spreadsheet configured for storing information related to possessions of the insured.

11. A method in accordance with claim 1 further comprising communicating between at least two parties to an insurance claim for the insured item via a communication web page on the sever.

12. A system for facilitating replacement of an insured item of an insured, said system comprising:
a plurality of devices; and
a server coupled to said plurality of devices, said server configured to receive specification information data from a first party about the insured item via a first device of said plurality of devices, wherein the specification information includes at least one of a feature of the item, said server further comprising an interface configured to:
compare the received item specification information with potential replacement product information pre-stored within at least one of said server and a database to identify at least one comparable item that is comparable to the insured item;
compile a list of the at least one comparable item, the list including specification information related to the at least one comparable item;
display the compiled list to at least the insured via a second device of said plurality of devices;
prompt the insured to select the at least one comparable item for comparison with the insured item; and
display a comparison between at least one feature of the at least one comparable item and at least one feature of the insured item.

13. A system in accordance with claim 12 wherein said interface is further configured to display the compiled list including at least one of a real-time price of the at least one comparable item, a real-time availability of the at least one comparable item, and a definition of the least one feature.

14. A system in accordance with claim 12 wherein said interface is further configured to display a feature-by-feature comparison between features of the at least one comparable item and features of the insured item.

15. A system in accordance with claim 12 wherein said interface is further configured to display an estimate of at least one of a repair process and a replacement process for the insured item to at least the insured, the estimate at least one entered into said server, exported to said server, and uploaded to said server.

16. A system in accordance with claim 12 wherein said interface is further configured to prompt the insured to select the at least one comparable item to be held as a possible replacement item for the insured item.

17. A system in accordance with claim 12 wherein said interface is further configured to:
prompt the insured to select the at least one comparable item as a replacement item for the insured item; and
indicate that the replacement item is being provided to the insured.

18. A system in accordance with claim 12 wherein said interface is further configured to:
prompt the first party to select at least one educational topic related to an insurance claim for the insured item; and
display at least one educational link to the insured, wherein the at least one education link directs the insured to an educational web page related to the at least one selected educational topic.

19. A system in accordance with claim 12 wherein said interface is further configured to display information related to at least one vendor, wherein the displayed information includes at least one of a vendor name, vendor contact information, a vendor rating, and link to select the at least one vendor.

20. A system in accordance with claim 12 wherein said interface is further configured to at least one of:
prompt the insured to store at least one digital copy a document on the server;
prompt the insured to access a pre-formatted spreadsheet configured for storing information related to possessions of the insured; and
provide a communication web page for facilitating communication between at least the first party and the insured via said server.
